(19) United States
(12) Patent Application Publication
(10) Pub. No.: US 2002/0057300 A1
(43) Pub. Date: May 16, 2002

(54) System for printing and applying tape onto surfaces

(75) Inventors: Daniel D Baker, St. Paul, MN (US); Gary L. Romberg, River Falls, WI (US); Lloyd S. Vasilakes, Stillwater, MN (US)

Correspondence Address: Office of Intellectual Property Counsel, 3M Innovative Properties Company, PO Box 33427, St. Paul, MN, 55133-3427, US

(73) Assignee: 3M Innovative Properties Company

(21) Appl. No.: 10/038,213

(22) Filed: Jan. 3, 2002

Related U.S. Application Data
(63) Continuation of application No. 09/592,477, filed on Jun. 9, 2000.

(51) Int. Cl. B41J 3/00

(52) U.S. Cl. 347/2

(57) ABSTRACT

An apparatus for printing variable information on a tape to form a tape segment, applying the tape segment onto an object, and cutting the tape segment includes a printer for printing information onto the tape segment. A controller controls the printer in response to input to vary the information printed onto the tape. The printed tape segment is transported to a location for application onto the object and is cut. The unwind tension of the tape as the tape is removed from the tape roll is controlled to present the tape to the printer at a substantially uniform speed and to reduce jerkiness of the tape. The information is registered such that it is placed at a predetermined location on different tape segments.

### TECHNICAL FIELD

The present invention relates to printing tape. More particularly, the present invention relates to printing on tape and applying the tape onto surfaces.

### BACKGROUND OF THE INVENTION

Containers, packages, cartons, and cases, (referred to as “boxes”) for storing and shipping products typically use box sealing tape, an adhesive tape, to secure the flaps or covers so that the box will not accidentally open during normal shipment, handling, and storage. Box sealing tape maintains the integrity of a box throughout its entire distribution cycle. Box sealing tape can be used on other parts of boxes and on other substrates and can be used to function in a similar manner to labels. These tapes can be made in roll or pad form. They can be transparent, translucent, or opaque, and can have information printed or otherwise applied to, or contained within or on, the tape.

These boxes generally display information about the contents. This information, most commonly located on the box, might include lot numbers, date codes, product identification information, and bar codes. The information can be placed onto the box using a number of methods. These might include preprinting the box when it is manufactured, printing this information onto the box at the point of use with an inkjet coder that sprays a pattern of ink dots to form the image, or by using a flexographic ink rolling coder system. Other approaches include the use of labels, typically white paper with preprinted information either applied manually, or with an online automatic label applicator.

A recent trend in conveying information related to the product is the requirement to have the information specific for each box. For example, each box could carry specific information about its contents and the final destination of the product, including lot numbers, serial numbers, and customer order numbers. The information is typically provided on labels that are customized and printed on demand at the point of application onto the box. This is typically known as the ability to print “variable” information onto a label before it is applied onto the box. Two patents that disclose printed labels are U.S. Pat. Nos. 5,292,713 and 5,661,099.

One system for printing variable information involves thermal transfer ink printing onto labels using an ink ribbon and a special heat transfer printing head. A computer controls the printing head by providing input to the head, which heats discrete locations on the ink ribbon. The ink ribbon directly contacts the label so that when a discrete area is heated the ink melts and is transferred to the label. Another approach using this system is to use labels that change color when heat is applied (thermal labels). In another system, variable information is directly printed onto a box by an inkjet coder. A computer can control the ink pattern sprayed onto the box or onto a label.

Both thermal transfer and inkjet systems produce sharp images. Inkjet systems include piezo, thermal, continuous, and drop-on-demand. With both inkjet and thermal transfer systems, the print quality depends on the surface on which the ink is sprayed. It appears that the best system for printing variable information is one in which the ink and the print substrate can be properly matched to produce a repeatable quality image, especially bar codes, that must be read by an electronic scanner with a high degree of reliability.

A variety of applying systems are available that incorporate a printing system, computer-controlled heated printing head, and guiding systems for the thermal transfer ink ribbon label and the liner. The PA/4020 Dual Panel Printer/Applicator made by Diagraph Corp. (Earth City, Mo.), the 2138 Printer/applicator made by Label-Aire, Inc. (Fullerton, Calif.), and the 2800 Print/apply corner applicator made by Labeling Systems, Inc. (Oakland, N.J.) are some examples. These systems print on linered labels. The liner is the carrier for the label material. These systems print discrete messages onto the label, strip the label from its liner, and transfer the printed label onto a box. Although there are other materials available, such as polyesters, from which labels can be made, paper labelstock is the most popular because of its ready acceptance of thermal transfer ink and its low cost.

Minnesota Mining and Manufacturing Company of St. Paul, Minn. (3M) has sold an automatic system for applying pre-printed tape (with non-variable information) with bar codes since 1994 (Model Nos. TA 1340, TA1341, and TA1342). This system can apply a corner label onto a box while the box is conveyed through a case sealer, or it can apply pre-printed tape onto a flattened box before the box is opened. This system offers an inexpensive, simple alternative to linered labels.

Printable tapes for applying on boxes, such as those disclosed in U.S. Pat. Nos. 4,421,817; 5,242,888; 5,354,588; 5,478,880; and 5,560,293, are known. However, these tapes are not capable of sealing boxes and receiving printed information of very high quality.

A system that can print variable information onto tape and apply the tape onto boxes is disclosed in copending U.S. application Ser. Nos. 09/207,801 and 09/330,555, both assigned to 3M. This patent application describes a system for printing variable information on tape and applying it to boxes.

### SUMMARY OF THE INVENTION

The invention is an apparatus for printing information on a tape from a tape roll to form a tape segment. The apparatus includes a printer for printing information onto the tape and comprising a platen roller, a prestrip motor, and an overrunning clutch bearing. The prestrip motor prestrips the tape from the tape roll, and includes a roller. The prestrip motor controls the unwind tension of the tape as the tape is removed from the tape roll to present the tape to the printer at a substantially uniform speed and to reduce jerkiness of the tape as the tape passes through the printer. The overrunning clutch bearing allows the prestrip motor roller to turn without requiring the prestrip motor to rotate.

The invention can also include a controller which controls the printer in response to input to vary the information printed onto the tape and print variable information on the tape.

The printed tape segment can be transported to a location for application onto an object and is applied onto the object to perform next tape segment out application. The object onto which the tape segment is to be applied can be a box having sides, corners, and seams along which the box is sealed, and the tape segment can be applied onto at least one of the sides, the corners, and the seams of the box. Also, the tape segment can be applied along at least one of the seams of the box to seal the box with a tape segment that both is printed with information and that maintains the box closed during shipping and handling.

The printer can be a thermal transfer printer, an inkjet printer, or a laser printer.

The invention is also a case sealing apparatus for sealing boxes using the apparatus for printing.

In another embodiment, the apparatus includes a printer which includes a platen roller and a device which feeds unprinted tape. This device registers the information to be printed with a specific location on the tape. This allows specific printed information to be placed at a predetermined location on different tape segments regardless of variations in the printed material on each tape segment.

The apparatus can also include at least one fixed end roller and at least one movable dancer roller. The dancer roller is movable between a thread-up position adjacent the end roller which facilitates tape threading and at least one run position in which the printer operates. The dancer roller can be movable between a plurality of run positions including a home position and a depleted position. In the home position the dancer roller is farther from the fixed end roller than in the fully festooned position.

A registration sensor and a pause sensor can be used to signal when the dancer roller is in the home position. If the dancer roller passes the home position, the printer stops printing tape until the pause sensor is cleared and the dancer roller returns to the home position.

In another embodiment, the apparatus can include a printer having a platen roller and an antiwrap sensor which senses if the tape starts to wrap around the platen roller. If the antiwrap sensor detects tape, it signals the tape transporting part of the system to stop platen roller motion, thereby preventing the tape from wrapping around the platen roller and jamming.

The printer can also include a platen roller clutch which stops platen roller motion when the clutch is disengaged.

In another embodiment, the invention is an apparatus for printing information on a tape from a tape roll to form a tape segment including a printer; a platen roller; and a clutch. The clutch is at least one of: an electric clutch and an overrunning clutch bearing on the platen roller, and the clutch disengages the platen roller from a driving mechanism and permits tape to be threaded through the printer.

The invention is also a method of printing on the front, top, and rear portions of C-clips of tape before the C-clips are cut from a roll, wherein the C-clips have a desired overall length. The method includes the following steps: (a) printing first information on the front portion of a first C-clip; (b) printing second information on the top portion of the first C-clip; (c) printing third information on the rear portion of a second C-clip; (d) slewing the tape as needed to create the desired overall length of the first C-clip; and (e) repeating steps (a), (b), (c), and (d).

The method steps can be performed in order of (a), (b), (c), (d), and (e); (c), (a), (b), (d), and (e); and (b), (c), (a), (d), and (e).

### BRIEF DESCRIPTION OF THE DRAWINGS

FIG. 1 is a schematic view of a tape handling system and case sealer of the present invention.

FIG. 2 is a schematic view of the tape handling system in a first position.

FIG. 3 is a schematic view of the tape handling system of FIG. 2 in a second position.

FIG. 4 is a schematic view of the tape handling system of FIG. 2 in a third position.

FIG. 5 is a schematic view of the tape handling system of another embodiment of the present invention in a thread-up mode.

FIG. 6 is a schematic view of the tape handling system of FIG. 5 in a first or home position.

FIG. 7 is a schematic view of the tape handling system of FIG. 5 in a second position.

FIG. 8 is a schematic view of a tape anti-wrap system of the invention.

FIG. 9 is a schematic view of accumulator sensors of the invention.

FIG. 10 is a view of a tape segment to be applied as a C-clip showing the known order of printing.

FIG. 11 is a view of a tape segment to be applied as a C-clip showing the order of printing of the present invention.

### DETAILED DESCRIPTION

The invention includes a system for printing information on a tape. The tape can be applied to a surface of an object, such as a container, like a box or case. Throughout this description, the term “tape” generally means a substrate that is linerless (although a linered substrate can also be used); that can be supplied in a roll (such as a self-wound roll) or other form; and that is not precut. The term “tape segment” is used to mean a portion of tape that can convey information (such as by printing) and that can be affixed to a surface. Tape segments include the tape after it is printed (if it is to be printed), both before and after it is severed from the rest of the tape. The term “variable” printing means printing customized information on demand to form a tape segment. Information is any information, including words, symbols, graphics, bar codes, and holograms.

The system of this invention prints information onto a tape to form a tape segment, and can optionally vary the information placed on each tape segment to allow for an infinite variation of content and lengths to be produced from one supply roll of tape. The system can apply the printed tape segment onto a box either while the box is stationary or while the box is moving (such as while the box is being closed and sealed). The system can apply the tape segment on a side of the box to serve as a conveyor of information. Alternatively, it can apply the tape segment as an L-clip onto the corner of the box or a C-clip along a seam of the box to convey information, to serve as a box closure device (without print), or a combination conveyor of information and box closure device.

The invention improves recyclability of used boxes and reduces the amount of material required to provide a tape segment carrying variable information compared to current labeling systems, and can combine sealing the box and providing information. The system can automatically apply the tape segment onto boxes, as discussed above, or the printed tape segment can be dispensed for manual application.

The tape can be a single-coated pressure sensitive adhesive tape having a multiple layer construction including a backing layer. The backing layer can be, for example, a single or multiple layer plastic film backing. Suitable plastic film backings include polypropylene, polyethylene, copolymers of polypropylene and polyethylene, polyvinyl chloride (PVC), polyesters, and vinyl acetates. The polypropylene can include monoaxially-oriented polypropylene (MOPP), biaxially oriented polypropylene (BOPP), or sequentially or simultaneously biaxially oriented polypropylene (SBOPP). The backing material can be compostible, degradable, colored, printed, and can be of different surface textures or embossed. Pressure sensitive adhesive is coated onto one side of the backing and a release coating (such as a low adhesion backsize (LAB) layer) is optionally coated on the opposite side to allow the tape to unwind from itself when wound in a roll.

Because certain release coatings on pressure sensitive adhesive tapes are not intended to be printed, the ink may not securely anchor because it is poorly bonded to the surface of the release coating. The ink may be easily scuffed, marred, or distorted under normal use conditions. The release coating on the tape of the invention can accept ink, such as from a flexographic process or from a thermal transfer method. The release coating can prevent dirt from adhering to the surface of the backing and affecting the scannability of the tape. Using a compatible ink transfer ribbon printing onto the release coating can provide sufficiently high anchorage levels such that the ink can not be scuffed off. The release coating composition can be compatible with the adhesive composition and does not degrade the adhesive properties of the tape such as by being transferred to the adhesive composition.

Release coating compositions for the LAB layer of tapes in roll form may include silicone, alkyl, or fluorochemical constituents, or combinations as the release-imparting component. Useful release coating compositions for the invention include silicone containing polymers, such as silicone polyurethanes, silicone polyureas and silicone polyurethane/ureas, such as those described in U.S. Pat. Nos. 5,214,119; 5,290,615; 5,750,630; and 5,356,706, and silicone acrylate grafted copolymers described in U.S. Pat. Nos. 5,032,460; 5,202,190; and 4,728,571. Other useful release coating compositions can include fluorochemicalcontaining polymers such as those described in U.S. Pat. No. 3,318,852, and polymers containing long alkyl side chains such as polyvinyl N-alkyl carbamates (e.g., polyvinyl N-octadecyl carbamates) as described in U.S. Pat. No. 2,532,011, and copolymers containing higher alkyl acrylates (e.g., octadecyl acrylate or behenyl acrylate), such as those described in U.S. Pat. No. 2,607,711, or alkyl methacrylates (e.g., stearyl methacrylate) such as those described in U.S. Pat. Nos. 3,502,497 and 4,241,198, where the alkyl side chain includes from about 16 to 22 carbon atoms.

These release polymers can be blended with each other and with thermosetting resins or thermoplastic film-forming polymers to form the release coating composition. In addition, other additives may be used in the release coating compositions such as fillers, pigments, wetting agents, viscosity modifiers, stabilizers, anti-oxidants, and cross-linking agents.

Numerous other layers can be added to the tape, such as primers to increase adhesive layer adhesion to the backing layer. Also, printed material can be located on the first side of the backing layer under or over the adhesive, or on the second side of the backing layer under or over any LAB layer. This printed material can be any information like advertising or instructions. Also, an additional flood layer of ink or similar coating can be used to alter the opacity of the tape. The tape could contain deodorants, perfumes, antistatic materials, and encapsulated cleaning chemicals. Also, the release properties of the backing can be modified such that the backing and the adhesive cooperate to achieve desired unwind characteristics. The release properties of the backing can be modified, for example, by applying a low surface energy composition, priming, corona discharge, flame treatment, roughening, etching, and combinations thereof.

Many types of adhesives can be used. The adhesive can include hotmelt-coated formulations, transfer-coated formulations, solvent-coated formulations, water-based, and latex formulations. Examples of adhesives useful in the invention include those based on general compositions of polyacrylate; polyvinyl ether; diene-containing rubber such as natural rubber, polyisoprene, and polyisobutylene; polychloroprene; butyl rubber; butadiene-acrylonitrile polymer; thermoplastic elastomer; block copolymers such as styrene-isoprene and styrene-isoprene-styrene block copolymers, ethylene-propylene-diene polymers, and styrene-butadiene polymers; poly(alpha-olefin)s; amorphous polyolefins; silicones; copolymers of ethylene with vinyl acetate, ethyl acrylate, and ethyl methacrylate; polyurethanes; polyamides; epoxy resins; polyvinylpyrrolidone and vinylpyrrolidone copolymers; polyesters; and mixtures of the above. Additionally, the adhesives can contain additives such as tackifiers, plasticizers, fillers, antioxidants, stabilizers, pigments, diffusing particles, curatives, and solvents.

Useful adhesives include pressure sensitive adhesives. Pressure sensitive adhesives are normally tacky at room temperature and can be adhered to a surface by application of, at most, light finger pressure. A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

The invention can be used in combination with conventional printing systems or with the unique variable print and apply system, such as described in U.S. application Ser. No. 09/207,801. This system also improves upon the system described in U.S. application Ser. No. 09/330,555. This latter system permits information to be printed on a set location over and over; registers printed information on each tape segment; and controls the unwind tension of the tape as the tape is removed from the tape roll to present the tape to a printer at a substantially uniform speed with minimal jerkiness.

This invention enables print to be registered on boxes using conventional taping heads. Registration marks on the tape are not required.

In alternative embodiments, the length of the tape segment for each application can be varied using a mechanism triggered by a mark seen by a detector. (Conventional systems use a die cut label on a liner, which requires the customer to determine what label size is needed, and stock this size label for each application.) Using the invention, an infinite number of different tape segment lengths can be created using a single input roll of tape. The length of the tape segment can depend on where a registration mark is printed. This allows not only printing variable information onto the tape, but also adjusting each tape segment length to match the requirements of the printed message. The tape segment width remains constant from the same supply roll source.

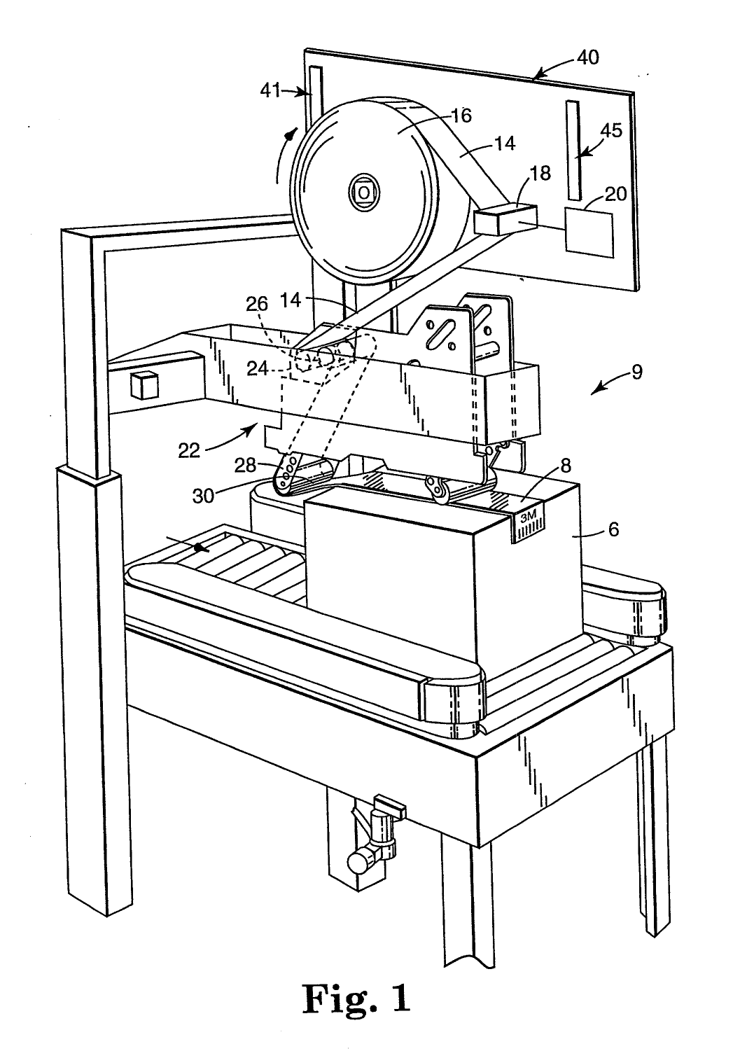

Tape can be printed and applied to any surface of a box in several ways, and the system can be mounted to a case sealer. One embodiment is shown in FIG. 1. The printer 18 prints the desired information on the tape 14 to form tape segments 8. The printer 18 can be an off-the-shelf printer, such as Model PE42 from Datamax Corporation (Orlando, Fla.), or a similar printer or print engine with or without modification, mounted onto the case sealer 9. Based on input, a controller 20 tells the printer 18 what to print on the tape 14 and how long the tape segments should be.

After printing, an applying mechanism 22 applies the tape segment onto a surface of the box 6, either before or after cutting the tape segment 8. The applying mechanism 22 can include an accumulator 24, which can include a dancer arm 26, and an applicator arm 28. The dancer arm 26 can provide the amount of tape 14 necessary to make up for any difference in speed between the case sealer 9, which generally runs at speeds of 25.4-50.8 cm/s (10-20 in/s) and the printer 18 which generally runs at speeds of 5.1-30.5 cm/s (2-12 in/s) for thermal transfer printers (ink jet printers run faster), depending on such characteristics as the resolution, the length of the tape segment, the type of ribbon, and the brand of printer. Also the dancer arm 26 can keep the tension essentially uniform at the output of the printer 18 to eliminate inaccuracies caused by overpulling the tape 14. Alternatively, the case sealer 9 could run at the same speed as the printer so that no dancer arm 26 is needed. An alternative to the dancer arm 26 is an open loop system (not shown), where the tape 14 is fed out of the printer 18, hangs down to form a loop, then travels to the taping head. A detector, such as a photosensor determines when the minimum loop is reached and allows the printer 18 to resume printing. Other systems for maintaining tape tension and matching the printer speed with the case sealer speed can be used.

After leaving the dancer arm 26 (or open loop), the printed tape 14 (as tape segments) moves to the applicator arm 28. When a box 6 being conveyed through the case sealer 9 contacts the applicator arm 28 on which the tape segment resides, the printed tape segment adheres to the box 6. The motion of the box 6 causes the applicator arm 28 to pivot and the applying roller 30 to apply the tape segment along one side of the box 6. For an L-clip, when the applying roller 30 on the applicator arm 28 reaches the corner of the box 6 it rolls around the corner and applies the same piece of tape around the corner and to the adjacent side of the box 6. For a C-clip, tape is applied to the front, top, and rear of the box 6. This method can be used on the upper taping head, the lower taping head, or on side mounted heads. Other versions of applicators can also be used.

The tape segment is severed by any type of cutting mechanism (not shown). In an embodiment where a registration mark is printed along with required tape segment information, when the registration mark passes by a detector such as a photosensor, an air cylinder is actuated, causing the applicator arm 28 to retract and change the tape path. The new tape path crosses the plane of the cutting mechanism. Continued movement of the box 6 causes the tape segment to be cut, and the box continues until it exits the machine. When the registration mark clears the photosensor, from the rmainder of the tape, the air cylinder returns to its home position. The printer 18 prints as preset independent of the application process. In another embodiment, the tape is cut by a standard cutoff mechanism present in known taping heads. Other devices for cutting can also be used.

In another embodiment, a flat surface applicator (FSA) can be used to apply tape to the sides of boxes. A printer and dancer arm are in the web path before the applicator. With this system, one or more tape segments of varying length and information can be applied to the same side of a box. A registration mark on the tape determines the length of the tape segment. A mark on the box or timer initiates the application.

Vacuum pad, vacuum belt, and vacuum wheel systems also can be used. In a vacuum wheel system, after the tape is printed, it is captured by the vacuum wheel and the tape segment is cut. The vacuum wheel rotates or moves on an arm, as necessary, to position the tape segment. The wheel moves between a first position in which the wheel receives the tape segment 8 and a second position in which the tape segment 8 is applied onto a surface, such as a box. The controller can be used to govern when the vacuum wheel is moved to the second position to apply the tape segment, for how long the vacuum wheel resides adjacent the surface, and when the vacuum wheel returns to the first position to receive another tape segment. This system can be adapted to apply both side tape segments as well as corner tape segments.

With many tapes, such as with linerless label stock, there is a tradeoff between easy, smooth unwind of the tape from its roll and print anchorage. If a release layer is used that requires a sufficiently low unwind force to permit smooth and easy unwind, the thermal transfer ink will not adhere to the tape. Generally, a silicone or other release agent is applied to the tape backing opposite the side with adhesive to reduce adhesion between the adhesive and the backing and to create a smooth, non-jerky unwind. Inks do not adhere well to certain types of release agents. However, release agents that permit good ink adherence or anchorage to the tape generally do not allow the tape to unwind smoothly. If the tape is jerky as it unwinds, it will be jerky as it travels through the printer, causing defects in the printed information. This is particularly detrimental when printing bar codes and other precise information. This is addressed by the unwind aspect of the invention in which tape with a printable release agent coating can be used in thermal transfer printers because of smoother delivery of tape to the printer. The tape construction can be optimized to provide the best quality print because the unwind characteristics are less of a concern.

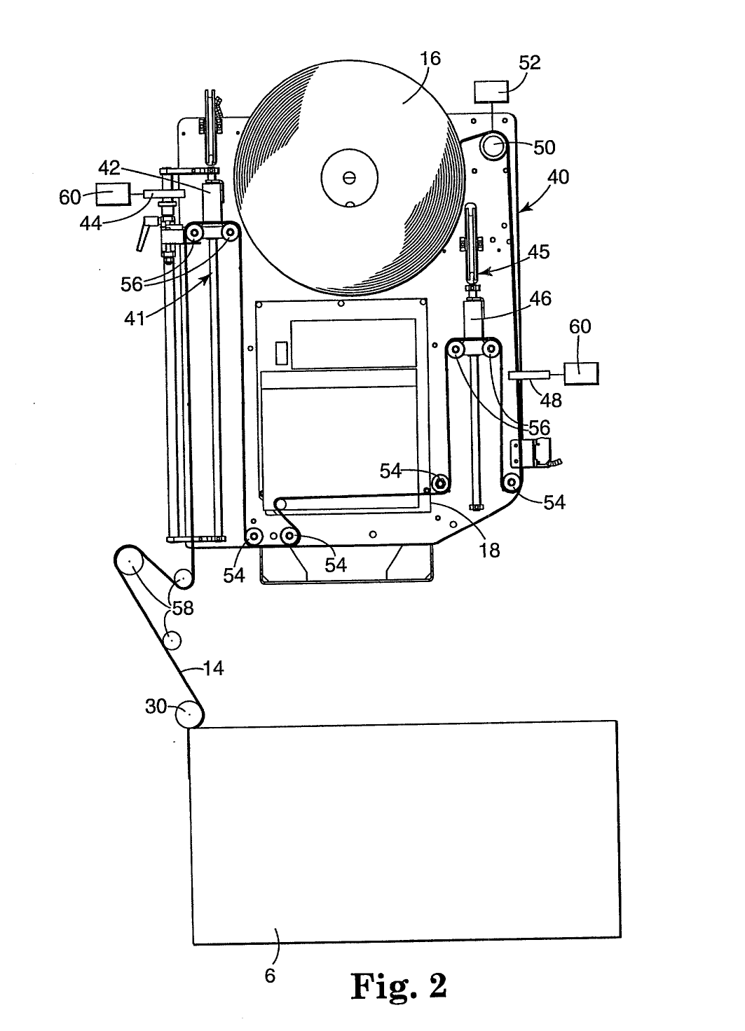

FIGS. 2-4 schematically show one system of the invention that prevents jerky tape travel through the printer and enables registration of the information on the tape. These two features are shown in one embodiment. However, they can be used independently and they will be described separately. The system 40, which can be mounted on a plate on a frame, uses an open loop control system to register the print on the tape segment 8. This is shown on the left side of FIGS. 2-4. The tape 14 is received from a tape supply such as a supply roll 16 and feeds it to the printer 18. From the printer 18, the tape 14 travels to the taping head of the case sealer 9. A first accumulator carriage 42 is located on the tape path between the printer 18 and taping head. The first accumulator carriage 42 is part of a first accumulator 41. At least one sensor 44 is located to detect motion of the first accumulator carriage 42.

The system 40 also uses an open loop control system or accumulator system to pass a tape with jerky unwind characteristics smoothly through the printer. This is shown on the right side of the FIGS. 2-4. Tape 14 from the supply roll 16 passes around a second accumulator carriage 46, called a supply side accumulator carriage, and a second sensor 48. The second accumulator carriage 46 is part of a second accumulator 45. A prestrip roller 50, driven by a motor 52 or other driver, can pull tape 14 from the supply roll 16. A mechanical arm, powered by an air cylinder or other device, can be used instead of the motor to assist prestripping. A series of idler rollers 54 are located along the tape path to guide the tape 14.

The path of the tape 14 from the supply roll 16 to the taping head, as shown in FIGS. 2-4, is as follows. The tape 14 from the supply roll 16 passes around the prestrip roller 50 and around an idler roller 54. It then passes through the second accumulator carriage 46, which itself can include rollers 56, and around another idler roller 54. Next, it passes through the printer 18, around one or more additional idler rollers 54, through the first accumulator carriage 42, which itself can include rollers 56, and around additional guide rollers 58 on the way to the taping head. The number and location of the idler rollers 54 and the guide rollers 58 can be varied as necessary to accommodate the configuration of both the system 40 and the case sealer 9.

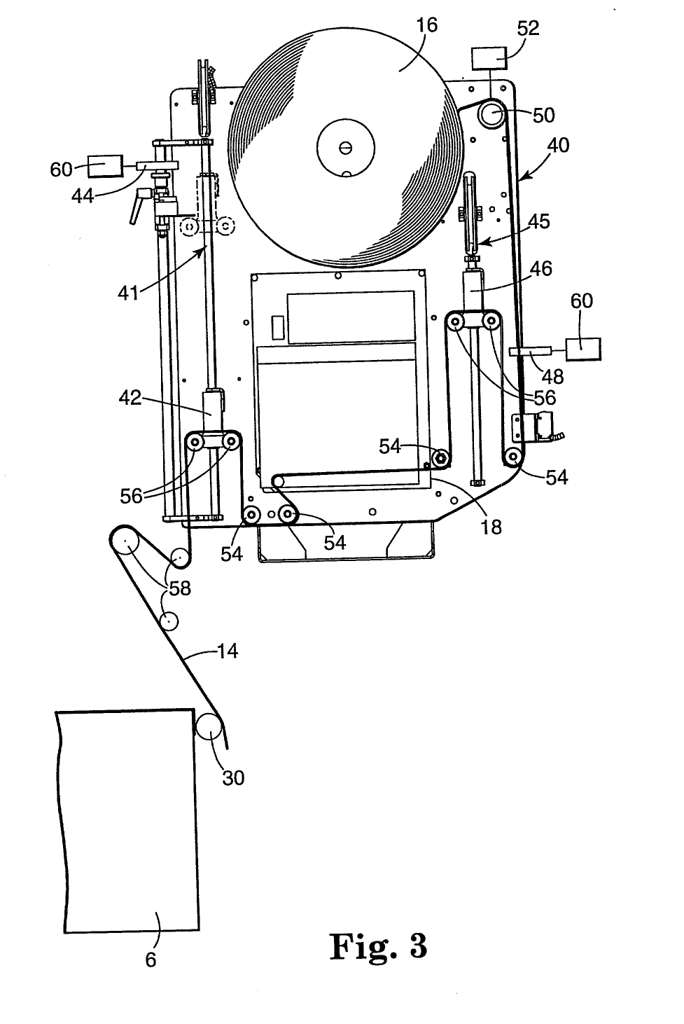

In varying the length of tape 14, or in using substantially the same length of tape 14 (with the same or different information printed on the tape) to create a tape segment 8, it may be necessary to control the length of the tape to make sure that each tape segment has the information in the proper (often same) location on the box 6. This requires registering the printed information on the tape segment. This system 40 allows a continuous length of tape 14 which is used to seal a box 6, and which can be applied in any manner, to be printed and applied to the box such that the printed information appears in substantially the same location on each box. For example, a product description and bar code could be printed on each end panel tape leg (see FIG. 1) so that it can be seen when stacked on a pallet for shipping. Registering the printed information on the tape segment using the system 40 is as follows. In the starting position shown in FIG. 2, tape 14 is on the applying roller 30, and a box 6 is fed into case sealer 9 and contacts the tape 14 on the taping head. This pulls tape 14 from the first accumulator 41 which causes the first accumulator carriage 42 to be pulled down, as shown in FIG. 3, to supply the tape to the box.

Upon detecting the downward motion of the first accumulator carriage 42, the sensor 44 sends a signal to a controller 60, such as a programmable logic controller (PLC), which sends a signal to the printer 18 to tell the printer to start printing. The printer 18 prints the required information to create a tape segment of a predetermined length. The length of the printed material should be slightly less than the average tape application length onto the box so that the printing does not extend to the edge of the tape segment 8.

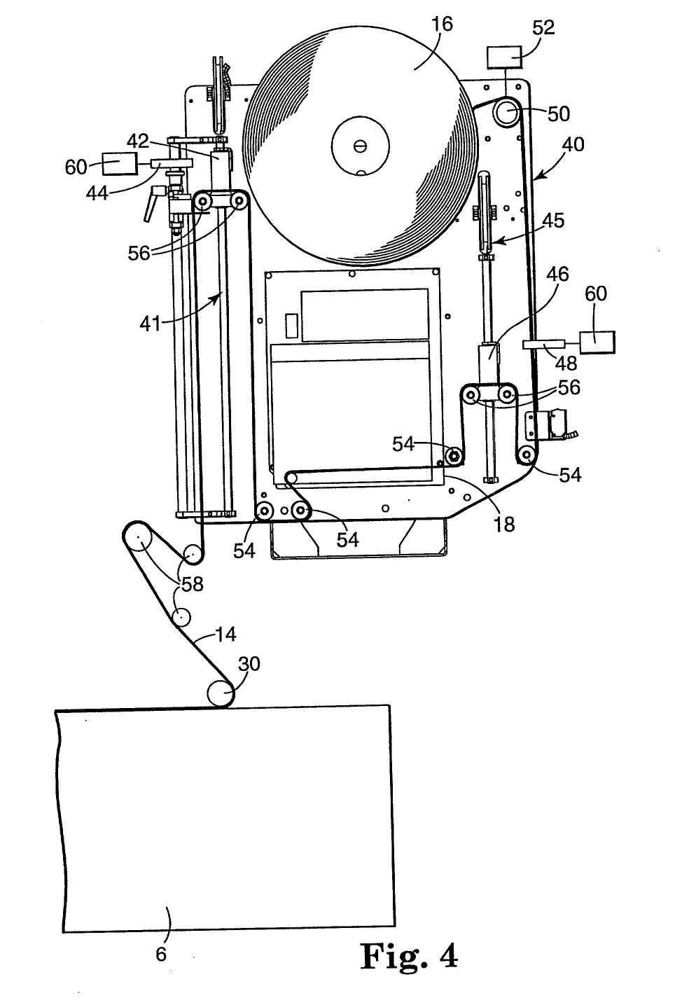

The taping head applies a previously-printed tape segment to the box 9 and cuts it off in any suitable manner. After the tape is applied to the box, the accumulator 42 moves upwardly toward its starting position because the printer 18 is still printing. After the printer 18 finishes printing, the printer sends a signal to the controller 60. If the sensor 44 does not detect the first accumulator carriage 42 because the carriage has not returned to its original position (shown in broken line in FIG. 3), the controller 60 sends a signal to the printer 18 to slew (feed without printing) tape 14 until the sensor 44 detects the first accumulator carriage 42 returned to its starting position shown in FIG. 2. FIG. 4 shows the first accumulator carriage 42 in the same position as FIG. 2. These Figures differ in the location of the second accumulator carriage 46.

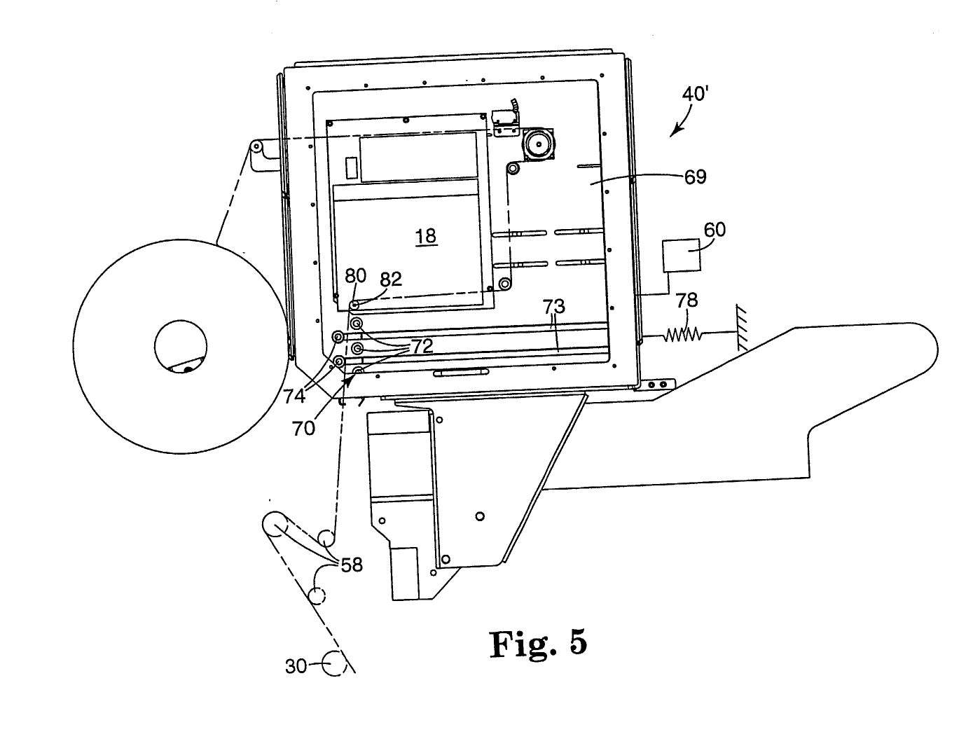

In another embodiment, referring to FIGS. 5-7, the first accumulator 41 is replaced by an accumulator 70 which includes a series of end rollers 72, which are fixed, and dancer rollers 74 which are mounted on a carriage 76 (not visible in FIG. 5) for movement. The carriage 76 can be biased by a device 78 which can be, for example, a torque motor, electric motor, pneumatic cylinder, spring, or counterweights. The first four of these have improved reaction times as compared with counterweights and also can be used in various orientations (weights must hang down). The design shown in FIGS. 2-4 uses weights to bias the first accumulator 41. As shown, in the embodiment of FIGS. 5-7, the carriage 76 of the accumulator 70 moves sideways.

An electric clutch or overrunning clutch bearing 82 on the platen roller 80 allows the tape 14 to be wrapped around the platen roller 80 and manually pulled through the printer 18 easily at thread-up. The clutch 82 disengages the platen roller 80 from the driving mechanism which is difficult to turn. Two operating modes are provided: run and thread-up.

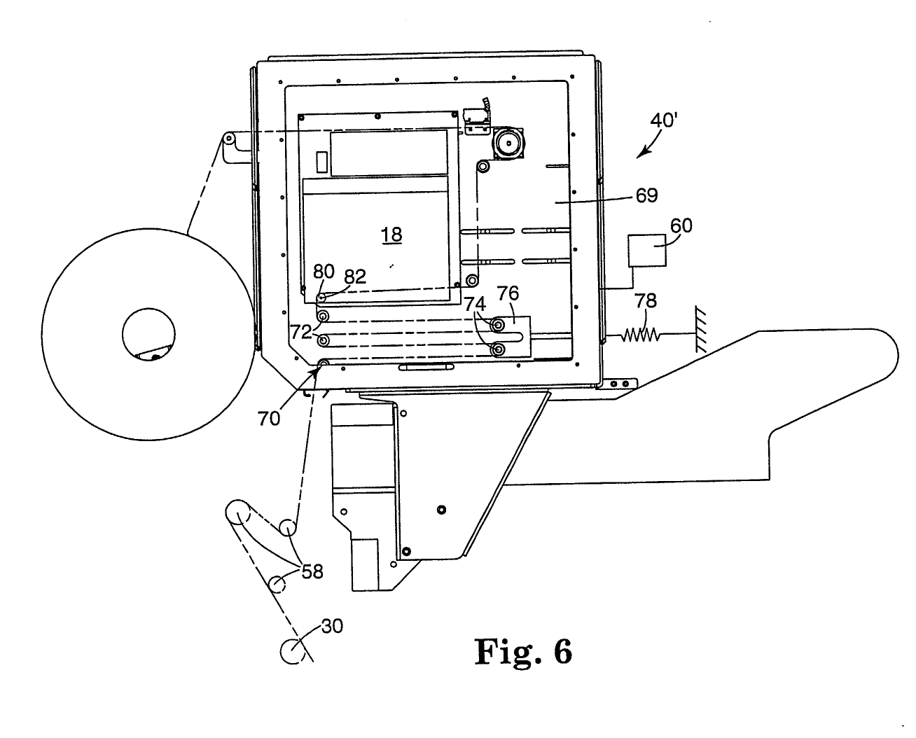

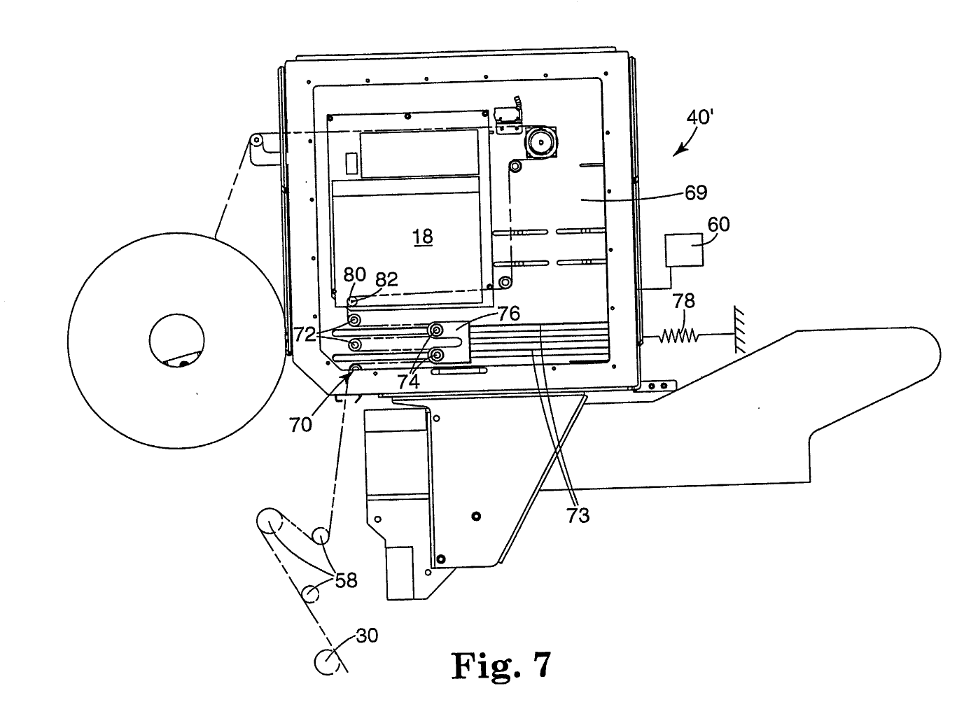

FIGS. 5-7 show three conditions of the system 40′. In FIG. 5, the system is in the thread-up position. FIGS. 6 and 7 are run conditions with the carriage 76 and dancer rollers 74 in the first and second positions, respectively. FIG. 6 is the home position and FIG. 7 is the depleted position in which the minimum tape is on the accumulator 70 for the particular operation. For illustration purposes only, FIG. 5 (and FIG. 9) shows an embodiment in which the carriage 76 is located behind the base plate 69 and the dancer rollers 74 protrude through slots 73. FIGS. 6 and 7 show an embodiment in which the carriage 76 is located in front of the base plate 69. (In reality the three conditions of FIGS. 5-7 would have the same structure.)

In the thread-up position, dancer rollers 74 are in the location shown in FIG. 5. These dancer rollers 74 can be manually moved or moved by a motor or air cylinder. The system 40′ is threaded as shown, with the tape 14 passing through the rollers 72, 74. After threading, the dancer rollers 74 are unlatched. When a machine reset button is pushed the dancer rollers 74 move to the home position, as shown in FIG. 6, in which the case sealer is adjusted to match box height and width. A home or registration position sensor 86 (shown in FIG. 9) is adjusted to match box length. Thus, in the home position the dancer rollers 74 can be located in any of an infinite number of locations to the right of the position of minimum tape accumulation (the depleted position) of FIG. 7.

In the run mode, shown in FIGS. 6 and 7, the dancer rollers 74 are moved to a position at the right side of the system 40′, further away from the end rollers 72 than in the thread-up position of FIG. 5. The dancer rollers 74 move between the home position of FIG. 6 and the position of FIG. 7. The box 6 enters the case sealer and contacts the tape 14. (The dancer rollers 74 are in the position of FIG. 6.) Tape 14 adheres to box 6 and the box begins to pull tape. The taping head, which includes the guide rollers 58 and the applying roller 30, applies tape to the front, top and rear of box 6 as usual. As tape 14 is pulled from the system, the carriage 76 (which creates a festoon) is pulled left from the home position. The registration sensor 86, shown in FIG. 9, detects when the carriage 76 of the accumulator 70 leaves the home position and sends a signal to the controller 60, which signals the printer 18 to begin printing. The printer 18 prints the subsequent tape segment at 10-25 cm/sec (4-10 in/sec) in the print zone and slews (feeds without printing) tape at approximately 30 cm/sec (12 in/sec) in non-printed zones. The box 6 is conveyed by the case sealer 9 at approximately 38 cm/sec (15 in/sec), faster than the tape is printed. The accumulated tape 14 in the accumulator 70 festoon allows this to occur. When printing is complete, the printer stops and signals the controller 60 which, in turn, signals the printer to begin slewing tape. This continues until dancer rollers 74 return to the home position of FIG. 6. In this way the same amount of tape is printed and slewed as the box has pulled from the system. Alternatively, the speed of the box through the case sealer 9 can match the speed of the printer, either by changing the printer speed based on a sensor measuring box speed or by changing the box speed based on a sensor measuring printer speed. In this case, a festoon may not be required.

In operation, as the box 6 pulls tape 14 from the system 40′ (without the printer printing), the carriage 76 moves toward the left in the Figures. As the printer 18 prints tape (without a box pulling tape) the carriage 76 moves toward the right in the FIGS. 5-7. When the box 6 is pulling tape 14 and the printer 18 is printing, the carriage moves toward the left in the Figures at a speed slower than would occur without printing. This is because the box pulls tape faster than the printer prints on tape.

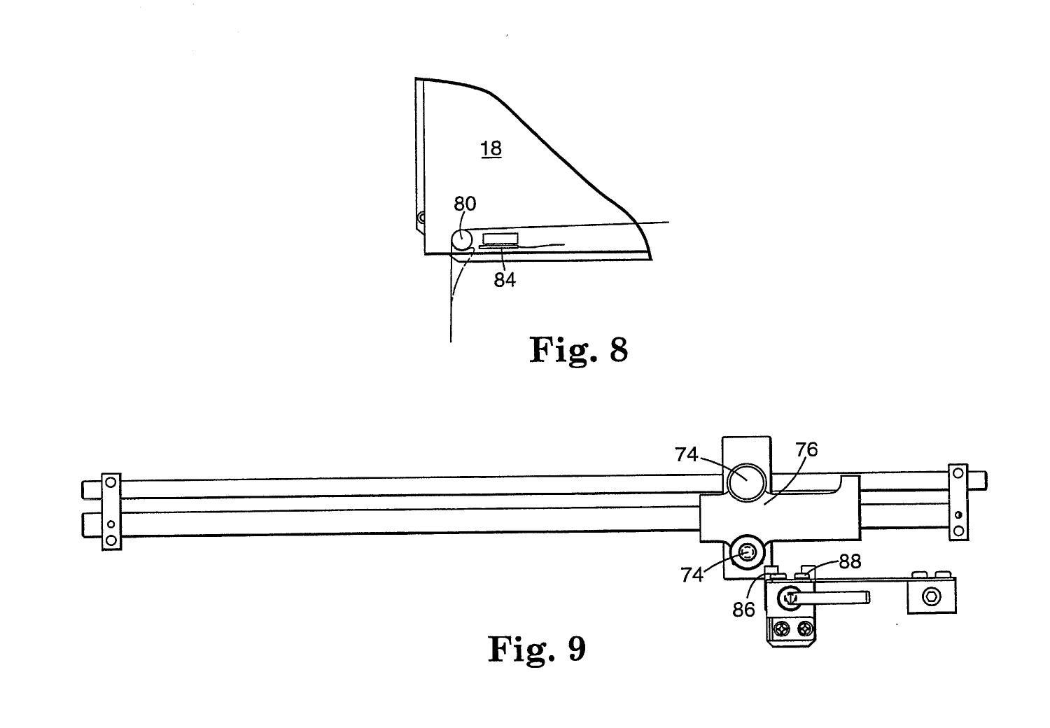

Referring to FIG. 8, an antiwrap sensor 84 can be used to sense if the tape 14 starts to wrap around the platen roller 80. As shown in broken line, if the antiwrap sensor detects tape 14, it signals the controller 60 to disengage the clutch 82 on the platen roller 80 or to otherwise immediately stop the printer and abort the job. This prevents the tape from wrapping around the platen roller and jamming. Although this stoppage is inconvenient, it is far superior to a tape jam which could require a long time to resolve, due in part to tape adhering to various rollers and other surfaces. Additionally, an optional dancer arm (not shown) can be used to maintain tension and can take up any slack in the tape 14 that is created between the platen roller 80 and the first stationary roller (end roller 72) after it. This also prevents platen roller “wrap-arounds.” The slack tape is a result of a difference in the response times of the printer stepper motor and the dancer carriage biasing device 78 which powers the dancer arm.

A folding handle (not shown) on the printer head can optionally be used to raise the printer head off the platen roller 80 and can, when it is in the “up” position, fold out in a perpendicular fashion away from the printer to allow easy access during ribbon changes.

This system also includes some novel and helpful control system features. There is a Pause function. The registration sensor 86 and a pause sensor 88 shown in FIG. 9, such as photocells, interpret festoon travel. The registration sensor 86 signals when the dancer rollers 74 and the carriage 76 are in the home position. If the carriage 76 travels passed this position and to the pause sensor, such as when boxes stop travelling through the case sealer 9, a signal is sent to the printer from the controller 60 to tell it to stop printing tape until the pause sensor 88 is cleared and the carriage 76 returns to the home position.

A Print Ready Signal is generated from the printer which activates when no tape segments are formatted or the printer is paused. This prevents a box from being fed into the machine when the printer is not ready to print.

When the printer is not printing it can feed media at up to 30.5 cm/s (12 in/s). The previous known maximum slew speed was 25.4 cm/s (10 in/s).

The media drive rollers on the printer change speed at a reduced acceleration to prevent a slack web due to slow festoon response time.

The Ignore Host Slew Command setting tells the printer to ignore the slew rate sent in the host tape segment format and instead to use the slew setting from the printer set up menu. The Host Abort Command is sent to the printer from the applicator. It tells the printer to abort printing the current tape segment if, for example, the anti-wrap sensor detects tape wrap-around, or the dancer arm is at the end of its travel. Also, a slew signal is sent from the applicator to the printer and tells the printer to feed out blank tape.

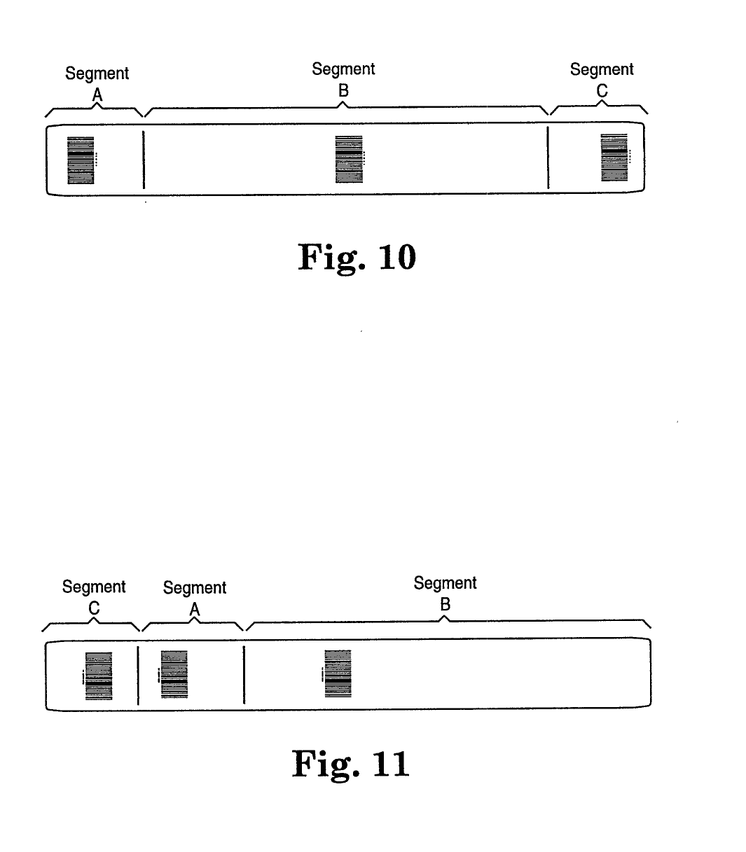

A tape segment to be applied to, for example, a 30 cm (12 in) long box would be designed at a length of approximately 43 cm (17 in). This would include 30 cm (12 in) along the top, segment B, and 7.1 cm (2.5 in) on each of the front and rear sides, segments A and C, respectively, minus 1.2 cm (0.5 in) for slew adjustment. The tape can be printed in order of segment A, then segment B, then segment C. This is shown in FIG. 10.

The inventors have improved on this, as shown in FIG. 11, by printing the information on the tape in CAB order (with segment C being the segment on the rear side of a first box and segments A and B being the front and top segments to be applied on a second box). This allows more of the front and rear portions (segments A and C) of tape to be printed by slewing on the top of the box rather than in the front or rear segments. The printer is given a slew command and slews from the end of segment B to the end of the box (the beginning of segment C). This is more forgiving than the ABC order of printing, which slews at the end of segment C, because it allows more slew to occur on the top segment B, where there is usually much more unprinted area (the legs have a higher percentage of printed area). The tape is applied onto a given box in ABC order. Segment C is applied to the rear of a first box, segment A is then applied to the front of the second box, segment B is applied to the top of the second box. The tape is cut between segments A and C by the taping head.

This formatting can be expressed in the following method steps: (a) printing first information on the front portion of a first C-clip; (b) printing second information on the top portion of the first C-clip; (c) printing third information on the rear portion of a second C-clip; (d) slewing the tape as needed to create the desired overall length of the first C-clip; and (e) repeating steps (a), (b), (c), and (d). The first, second, and third information can be the same or different, in any combination. In printing using the CAB order as shown in FIG. 11, these steps would be performed in the order of (c), (a), (b), (d), and (e). Also, step (b) can begin the process and the steps would be performed in (b), (c), (a), (d), (e) order.

In the unwind feature of the present invention, the tension of tape through the printer is controlled to allow tape that has good ink adherence characteristics and jerky unwind characteristics to have precise information printed accurately on it.

As shown in FIGS. 2-6, the motor-driven prestrip roller 50, which has high traction, is driven by the prestrip motor 52. The prestrip roller 50 is located between the supply roll 16 and the second accumulator carriage 46, downstream from the supply roll 16. The motor 52 drives the prestrip roller 50 which pulls the tape 14 off the supply roll 16 and feeds the tape 14 to the printer 18 at a low controlled tension, such as 4.45-22.24 N (1-5 lb). This allows using a printable release agent that typically has either high or jerky unwind characteristics or both. The prestrip roller 50 pulls the tape 14 off the supply roll 16, absorbs most of the unwind shock, and presents the tape 14 to the printer at a controlled uniform tension.

In another aspect of the invention, an overrunning clutch bearing, between the roller and its supporting shaft, on the prestrip motor 52 allows the tape 14 to be threaded manually and easily around the roller on the prestrip motor. The roller is allowed to turn (“freewheel”) without having to turn the motor, which has a gear reduction and is difficult to turn.

The sequence of operation of the smooth unwind feature of the system 40 of FIGS. 2-4 is as follows. First, as the first accumulator carriage 42 begins to draw tape (shown in FIG. 2), the printer 18 pulls tape 14 during the print cycle. This pulls down the second accumulator carriage 46 to feed tape into the printer, as shown in FIG. 4. When the accumulator carriage 46 moves down sufficiently for the sensor 48 to detect its presence, the sensor 48 sends a signal to the controller 60, which can be a separate controller or the same controller used for the sensor 44 at the first accumulator carriage 42. The controller 60 then sends an output signal to turn on the motor 52. The motor 52 drives the prestrip roller 50 which pulls tape 14 off of the supply roll 16. As tape is pulled from the supply roll 16 by the prestrip roller 50, the second accumulator carriage 46 clears the sensor 48, which no longer detects it, and the sensor sends a signal to the controller 60 to stop the motor 52 from driving the prestrip roller 50 and pulling the tape 14 from the supply roll 16. As the printer 18 pulls more tape, the accumulator carriage 46 may move down and up several times during the printing of a given tape segment.

The second accumulator carriage 46 is counterbalanced by a force, which can be provided in any suitable way, such as a torque motor, electric motor, pneumatic cylinder, spring or counterweights (not shown), designed to provide the proper tension to the tape.

In modifications of this system, two sensors 48 can be used. One would start the motor 52 and the other would stop it. In another embodiment, an analog sensor and motor control can be used so that motor speed is determined by the position of the second accumulator carriage 46. Also, a stepper motor can be used to drive the tape at the same rate as demanded by the printer.

The system can be used to print information onto the pressure sensitive adhesive tape that also seals the box. This eliminates the need for a secondary information-bearing tape segment. This reduces the amount of tape that is used and eliminates a major sub-component of the case sealer. This tape, therefore, must combine the required sealing properties with the property of being able to receive and hold ink. Also, information can be applied on the portion of the tape which forms the leg of the seal on the side of the box so that it can be read (or scanned) without having to see the top of the box.

The apparatus can operate with a given tape segment that is printed and is not immediately applied onto the next box. The tape segment is wound through a path, such as an accumulator or festoon, because it will be applied to a box that is several boxes upstream at the time immediately following printing. One or more previously printed tape segments must be applied after the given tape segment is printed and before the given tape segment is applied. Alternatively, the apparatus can operate on a “next tape segment out” protocol. That is, after the tape segments are printed, they are not placed in a queue to allow one or more previously printed segments of tape to be applied. In the next tape segment out system, a tape segment is printed and is the next segment to be applied. There is no accumulation of printed tape segments.

Additional features can be used in various combinations with the invention. A ribbon saver feature can stop feeding ribbon when tape is travelling through the printer but long spaces on the tape are not printed. Heat can be used to fuse and anchor ink printed directly on standard box sealing tape backing or on the LAB layer of the backing. Alternatively, ink printed on standard tape can be over-laminated with a clear coat of, for example, a varnish or with a clear tape to protect the ink. These over-laminating processes could facilitate additional printing in or near an area already containing printed information. Also, a plain strip of paper, printed using a low cost wax ribbon or ink jet printing, can be over-laminated with a clear low cost film tape that is wider than the paper strip. The film tape would extend beyond the boundaries of the paper strip and create a printed, pressure sensitive adhesive tape segment.

Various changes and modifications can be made in the invention without departing from the scope or spirit of the invention. For example, although the embodiments shown use thermal ribbon printing, direct thermal, inkjet coding and other printing systems also can be used. The tape can be preprinted with nonvariable information, with one or more areas or fields left blank. Variable information can be printed to fill in the blanks. Also, reverse image printing could occur on the adhesive portion of the tape. Additionally, the various features of FIGS. 2-4 and 5-7 can be interchanged to customize a system for a desired use. The disclosures of all patents and patent applications mentioned in this application are incorporated by reference.

1. An apparatus for printing information on a tape from a tape roll to form a tape segment comprising:
a printer for printing information onto the tape and comprising a platen roller;
a prestrip motor for prestripping the tape from the tape roll, wherein the prestrip motor comprises a roller, and wherein the prestrip motor controls the unwind tension of the tape as the tape is removed from the tape roll to present the tape to the printer at a substantially uniform speed and to reduce jerkiness of the tape as the tape passes through the printer; and
an overrunning clutch bearing which allows the prestrip motor roller to turn without requiring the prestrip motor to rotate.

2. The apparatus of claim 1 further comprising a controller which controls the printer in response to input to vary the information printed onto the tape and print variable information on the tape.

3. The apparatus of claim 2 wherein the printed tape segment is transported to a location for application onto an object and is applied onto the object to perform next tape segment out application.

4. The apparatus of claim 1 wherein the object onto which the tape segment is to be applied is a box having sides, corners, and seams along which the box is sealed, and wherein the tape segment is applied onto at least one of the sides, the corners, and the seams of the box.

5. The apparatus of claim 4 wherein the tape segment is applied along at least one of the seams of the box to seal the box with a tape segment that both is printed with information and that maintains the box closed during shipping and handling.

6. The apparatus of claim 1 wherein the printer comprises at least one of: a thermal transfer printer, an inkjet printer, and a laser printer.

7. A case sealing apparatus for sealing boxes using tape and comprising the apparatus of claim 1.

8. An apparatus for printing information on a tape to form a tape segment comprising:
a printer for printing information onto the tape and comprising a platen roller; and
means for registering the information to be printed with a specific location on the tape to allow specific printed information to be placed at a predetermined location on different tape segments regardless of variations in the printed material on each tape segment.

9. An apparatus for printing information on a tape to form a tape segment comprising:
a printer for printing information onto the tape and comprising a platen roller; and
a device which feeds unprinted tape, as necessary, to register the information to be printed with a specific location on the tape, thereby to allow specific printed information to be placed at a predetermined location on different tape segments regardless of variations in the printed material on each tape segment.

10. The apparatus of claim 9 wherein the printed tape segment is transported to a location for application onto the object and is applied onto the object to perform next tape segment out application.

11. The apparatus of claim 9 wherein the object onto which the tape segment is to be applied is a box having sides, corners, and seams along which the box is sealed, and wherein the tape segment is applied onto at least one of the sides, the corners, and the seams of the box.

12. The apparatus of claim 11 wherein the tape segment is applied along at least one of the seams of the box to seal the box with a tape segment that is printed with information and that maintains the box closed during shipping and handling.

13. The apparatus of claim 9 wherein the printer comprises at least one of: a thermal transfer printer, an inkjet printer, and a laser printer.

14. The apparatus of claim 9 further comprising a controller that controls the printer in response to input to vary the information printed onto the tape.

15. A case sealing apparatus for sealing boxes using tape and comprising the apparatus of claim 9.

16. The apparatus of claim 9 further comprising at least one fixed end roller and at least one movable dancer roller, wherein the dancer roller is movable between a thread-up position adjacent the end roller which facilitates tape threading and at least one run position in which the printer operates.

17. The apparatus of claim 16 wherein the dancer roller is movable between a plurality of run positions including a home position and a depleted position, wherein in the home position the dancer roller is farther from the fixed end roller than in the depleted position.

18. The apparatus of claim 16 further comprising a registration sensor and a pause sensor, wherein the registration sensor signals when the dancer roller is in the home position, and wherein if the dancer roller passes this position the printer stops printing tape until the pause sensor is cleared and the dancer roller returns to the home position.

19. An apparatus for printing information on a tape to form a tape segment comprising:
a printer for printing information onto the tape and comprising a platen roller; and
means for preventing the tape from wrapping around the platen roller and jamming.

20. An apparatus for printing information on a tape to form a tape segment comprising:
a printer for printing information onto the tape and comprising a platen roller; and
an antiwrap sensor which senses if the tape starts to wrap around the platen roller, wherein if the antiwrap sensor detects tape, it signals the tape transporting part of the system to stop platen roller motion, thereby preventing the tape from wrapping around the platen roller and jamming.

21. The apparatus of claim 20 wherein the printer further comprises a platen roller clutch and wherein platen roller motion is stopped by disengaging the platen roller clutch.

22. An apparatus for printing information on a tape from a tape roll to form a tape segment comprising a printer for printing information onto the tape; a platen roller; and a clutch which is at least one of: an electric clutch and an overrunning clutch bearing on the platen roller, wherein the clutch disengages the platen roller from a driving mechanism and permits tape to be threaded through the printer.

23. A method of printing on the front, top, and rear portions of C-clips of tape before the C-clips are cut from a roll, wherein the C-clips have a desired overall length, comprising the following steps:
(a) printing first information on the front portion of a first C-clip;
(b) printing second information on the top portion of the first C-clip;
(c) printing third information on the rear portion of a second C-clip;
(d) slewing the tape as needed to create the desired overall length of the first C-clip; and
(e) repeating steps (a), (b), (c), and (d).

24. The method of claim 23 wherein the order of performance of the steps is one of: (a), (b), (c), (d), and (e); (c), (a), (b), (d), and (e); and (b), (c), (a), (d), and (e).
